(19) United States
(12) Patent Application Publication
(10) Pub. No.: US 2003/0115264 A1
(43) Pub. Date: Jun. 19, 2003

(54) Network-connection guiding device, network-connection guiding method and storage medium

(75) Inventor: Shushi Takiyama, Inagi (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/289,246

(22) Filed: Nov. 7, 2002

Related U.S. Application Data
(63) Continuation of application No. PCT/JP00/02937, filed on May 8, 2000.

(51) Int. Cl. G06F 15/16; G06F 17/60

(52) U.S. Cl. 709/203; 705/14

(57) ABSTRACT

A network connection guiding device of the present invention includes a connection module for connecting the network connection guiding device as an auxiliary input device to a network connection controlling device for controlling a connection to a network, a request module for making a processing request for making the network connection controlling device control the connection to the network on the basis of connecting destination specifying information retained by the network connection controlling device, and a storage unit stored with connecting destination specifying information of which the network connection controlling device is notified. According to the present invention, a user can be enticed into a predetermined network service without being time-consuming in operation by the user.

### BACKGROUND OF THE INVENTION

The present invention relates to a device for guiding a user into accessing an IP (Internet Protocol) communication network typically known as the Internet, and more particularly to a network connection guiding device and a network connection guiding method that are capable of guiding and enticing the user into a specified network service by distributing a novelty goods (a mascot robot) and thus increasing the number of users.

Over the recent years, with an explosive development of the Internet following spreads of information communication terminal devices such as personal computers, set-top boxes and so on, the Internet is utilized as one method for advertisements and sales as well.

A service provider (including an entrepreneur and an administrator) for providing an Internet homepage connection service as a specified network service, sets up a homepage for advertising enterprises, selling commercial articles and so forth. In the present situation, however, the user is required to access the homepage by manually inputting a homepage address (a network address) such as URL (Uniform Resource Locator) or an IP address, or utilizing a search service, or tracing links as destinations of jumping to various categories of information.

If the user does not feel like browsing the homepage, however, the homepage is not opened. Under this circumstance, it is required that the homepage provider enhances a degree of recognition by giving a variety of advertisements in order to motivate the user to see the homepage so that the user memorizes a character string of URL or an IP address as a homepage address.

Further, there exist some personal computers as information communication terminal devices each provided with an Internet connection button operated by one touch to obtain a content of the homepage, thereby enabling the user to browse the homepage.

It is, however, unknown by intuition what homepage is registered on this one-touch button, and it is not yet recognized by the general users what happens by operating the one-touch button. Further, in the case of providing the one-touch button and a bookmark, the user needs to register homepages corresponding thereto.

After all, the methods in the prior arts described above can not obviate the following problems. A first problem (1) is that even when the homepage provider places the advertisement, there is no assurance that he user invariably browses this homepage. A second problem (2) is that it is difficult for the user to memorize URL specifying a desired homepage. A third problem (3) is that if a search word inputted by the user does not hit, a desired homepage can not be browsed in the search service. A fourth problem (4) is that a large quantity of information hit by the search word is displayed in the search service, and a desired item of information might often be overlooked because of being hidden behind other items of information. Finally, a fifth problem (5) is that a banner advertisement gets stereotyped and is therefore ignored.

### SUMAMRY OF THE INVENTION

It is a primary object of the present invention to provide a method capable of enticing a user into a desired network service without being time-consuming in operation by the user.

It is another object of the present invention to provide a network connection guiding device assuming an external configuration or shape enabling the user to intuitively specify a network service provider or a service content.

It is a further object of the present invention to provide a network connection guiding device that can be distributed as a novelty goods such as a mascot robot to the user.

To accomplish the above objects, a first network connection guiding device of the present invention includes a connection module connecting the network connection guiding device as an auxiliary input device to a network connection controlling device controlling a connection to a network, and a request module making a processing request for making the network connection controlling device control the connection to the network on the basis of a piece of connecting destination specifying information retained by the network connection controlling device.

A second network connection guiding device of the present invention includes a connection module connecting the network connection guiding device as an auxiliary input device to a network connection controlling device controlling a connection to a network, a storage module stored with the connecting destination specifying information of which the network connection controlling device is notified, and a request module making a processing request for making the network connection controlling device control the connection to the network on the basis of the connecting destination specifying information.

A third network connection guiding device of the present invention includes a connection module connecting the network connection guiding device as an auxiliary input device to a network connection controlling device controlling a connection to a network, a request module making a processing request for making the network connection controlling device control the connection to the network on the basis of a piece of connecting destination specifying information retained by the network connection controlling device, and a storage module stored with identifying information for identifying the connecting destination specifying information.

A fourth network connection guiding device of the present invention further includes a detection module detecting an even occurrence time on the basis of time information acquired from the network connecting destination specified by the connecting destination specifying information, and a display unit displaying an arrival of the event occurrence time leastwise visibly or audibly.

A fifth network connection guiding device of the present invention further includes a display unit displaying an occurrence of an updating state leastwise visibly or audibly on the basis of update information acquired from the network connecting destination specified by the connecting destination specifying information.

A sixth network connection guiding device of the present has an external configuration associated with a network service specified by the connecting destination specifying information.

A seventh network connection guiding device of the present invention has an external configuration into which an animal, a human being, a robot or an imaginary creature is characterized, the network connection destination is notified of input information as a user's action on the character via the network connection controlling device, and the character is set in motion based on output information obtained from this connecting destination.

A first network connection guiding method of the present invention includes detecting a processing request from a network connection guiding device as an auxiliary input device, and controlling a connection to a network on the basis of a piece of connecting destination specifying information retained therein when detecting the processing request.

A second network connection guiding method of the present invention includes detecting a processing request from a network connection guiding device as an auxiliary input device, and controlling a connection to a network on the basis of a piece of notified connecting destination specifying information when detecting the processing request.

A third network connection guiding method of the present invention includes detecting a processing request from a network connection guiding device as an auxiliary input device, and controlling a connection to a network on the basis of a piece of retained connecting destination specifying information corresponding to the notified identifying information when detecting the processing request.

According to the present invention, there is provided a first storage medium stored with a program executed by a computer, the program including detecting a processing request from a network connection guiding device as an auxiliary input device, and controlling a connection to a network on the basis of a piece of connecting destination specifying information retained therein when detecting the processing request.

According to the present invention, there is provided a second storage medium stored with a program executed by a computer, the program including detecting a processing request from a network connection guiding device as an auxiliary input device, and controlling a connection to a network on the basis of a piece of notified connecting destination specifying information when detecting the processing request.

According to the present invention, there is provided a third storage medium stored with a program executed by a computer, the program including detecting a processing request from a network connection guiding device as an auxiliary input device, and controlling a connection to a network on the basis of a piece of retained connecting destination specifying information corresponding to the notified identifying information when detecting the processing request.

A fourth network connection guiding method of the present invention includes connecting a network-connection guiding device to a network-connection controlling device wherein the network-connection guiding device is distributed as a novelty goods, is connectable to the network-connection controlling device and includes an operation mechanism, and setting the network connection guiding device in motion by receiving pre-stored motion information from a network connecting destination on the basis of connecting destination specifying information retained by the network connection controlling device.

A fifth network connection guiding method of the present invention includes connecting a network-connection guiding device to a network-connection controlling device wherein the network-connection guiding device is distributed as a novelty goods, is connectable to the network-connection controlling device, stored with connecting destination specifying information and includes an operation mechanism, notifying the network connection controlling device of the connecting destination specifying information from the network connection guiding device, and setting the network connection guiding device in motion by receiving pre-stored motion information from a network connecting destination on the basis of connecting destination specifying information.

A sixth network connection guiding method of the present invention includes connecting a network-connection guiding device to a network-connection controlling device wherein the network-connection guiding device is distributed as a novelty goods, is connectable to the network-connection controlling device, stored with identifying information for identifying connecting destination specifying information and includes an operation mechanism, notifying the network connection controlling device of the identifying information for identifying the connecting destination specifying information retained by the network connection controlling device from the network connection guiding device, and setting the network connection guiding device in motion by receiving pre-stored motion information from a network connecting destination on the basis of connecting destination specifying information.

According to the present invention, the user can be enticed into a desired network service without being time-consuming in operation by the user.

Further, according to the present invention, the user can intuitively recognize and memorize the network service by adopting, for an external configuration, a symbol mark, a character design etc associated with a provider or a content of the network service. It is therefore feasible to sharply decrease a possibility in which the user might forget the service or might confuse the desired service with other service and connect to this other service.

Moreover, according to the present invention, the number of users can be increased by distributing mascot robots etc (the network connection guiding devices) as novelty goods to the users.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a view showing an outline of architecture of a network service user enticement system in a first embodiment;

FIG. 2 is a view showing a detailed architecture of the network service user enticement system in the first embodiment;

FIG. 3 is an explanatory flowchart showing operations in the first embodiment;

FIG. 4 is a view showing a detailed architecture of the network service user enticement system in a second embodiment;

FIG. 5 is an explanatory flowchart showing operations in the second embodiment;

FIG. 6 is a view showing a detailed architecture of the network service user enticement system in a third embodiment;

FIG. 7 is an explanatory flowchart showing operations in the third embodiment;

FIG. 8 is a view showing a detailed architecture of the network service user enticement system in a fourth embodiment; and

FIG. 9 is an explanatory flowchart showing operations in the fourth embodiment.

### DETAILED DESCRIPTION OF THE PREFERRED EMBODIMENTS

Next, embodiments of the present invention will hereinafter be described with reference to the accompanying drawings.

[Architecture in First Embodiment]

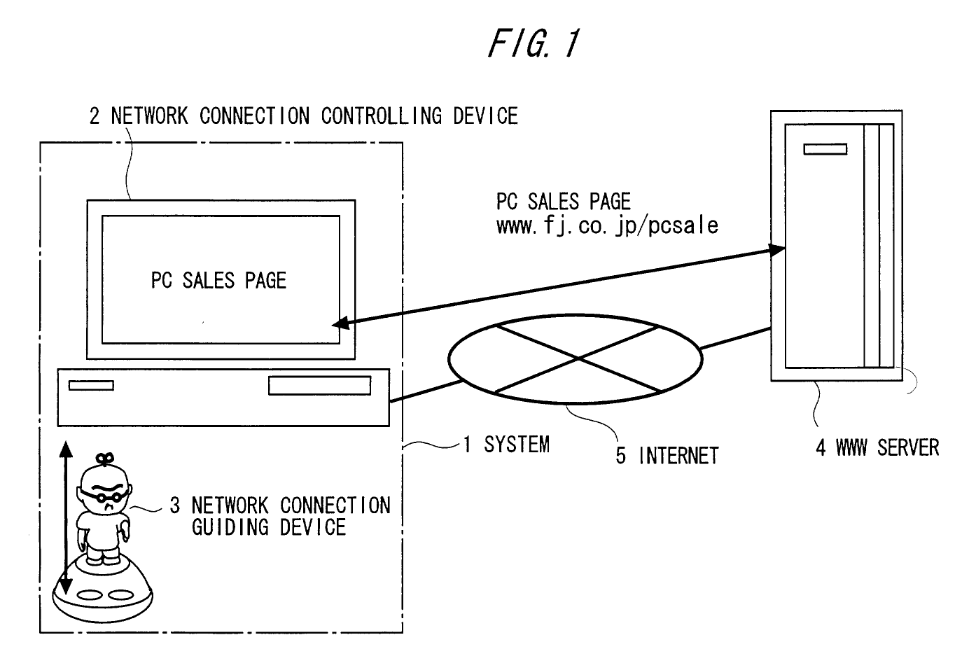

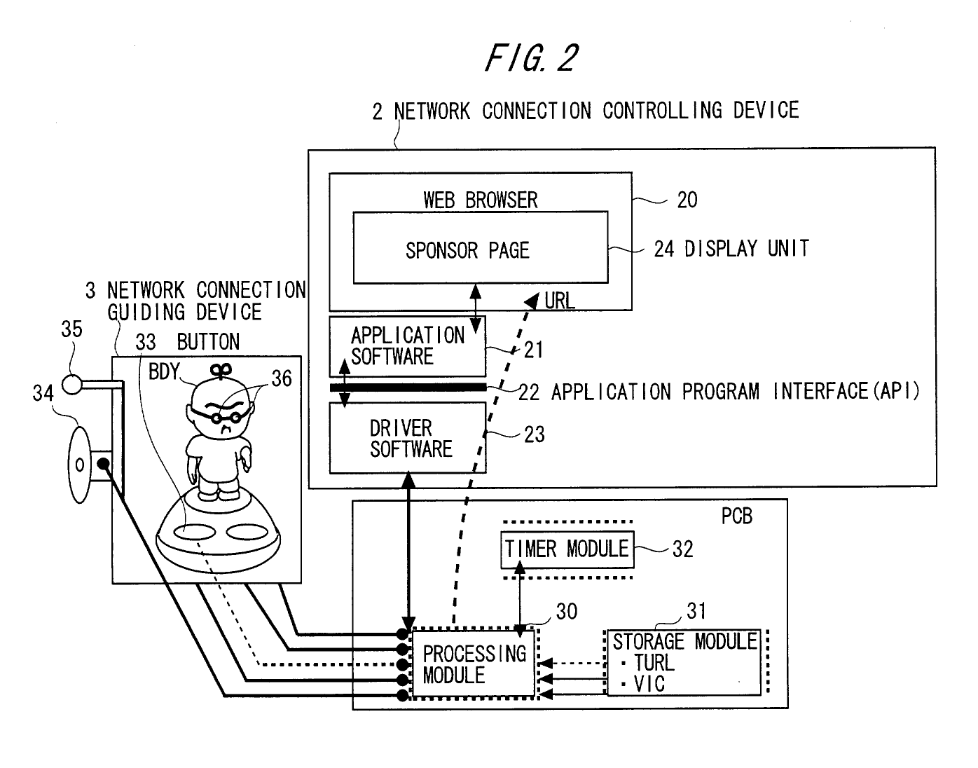

FIGS. 1 and 2 illustrate a first embodiment of the present invention. Referring to FIGS. 1 and 2, a system (network service user enticement system) 1 is configured by a network connection controlling device 2 and a network connection guiding device 3. The network connection controlling device 2 of this system 1 is connected to an Internet 5 defined as an IP (Internet Protocol) communication network accommodating a WWW (World Wide Web) server 4.

The network connection controlling device 2 can be actualized by a personal computer or a set-top box categorized as an information communication terminal device. According the first embodiment, the network connection controlling device 2 is actualized by the personal computer (which will hereinafter be abbreviated to PC). The network connection controlling device 2 includes, as FIG. 2 shows a detailed architecture, a Web browser 20, application software 21, an application program interface (API) 22, driver software 23 and a display unit 24.

The network connection guiding device 3 takes an external configuration as a mascot robot titled [Mr. Touch] (which is a registered trademark of Fujitu Co., Ltd.). This guide device 3 is connected as a sub-I/O device to the network connection controlling device 2 and supplied with electric power, thereby operating in a way that entices, as will be explained later on, the user of the network connection controlling device 2 into a homepage by way of a specified network service.

To be more specific, a company aiming at improving a homepage access hit rate distributes the mascot robot (a character doll made by the company itself) as a novelty goods and has this mascot robot utilized as the sub-I/O device. The mascot robot as the network connection guiding device 3 incorporates a function of enabling the user, upon pressing a predetermined button, to browse a specified homepage.

The network connection guiding device 3 is, as FIG. 2 shows the detailed architecture, connected to the network connection controlling device 2 via USB (Universal Serial Bus), an RS232C cable, or an interface defined by IEEE1394. This guide device 3 includes a processing module 30 constructed of a microprocessor, a storage module 31 constructed of EPROM (Erasable Programmable Read-Only Memory), a timer module 32, a button 33, a loudspeaker 34, microphone 35 and light emitting display modules 36 using LEDs (Light Emitting Diodes).

The processing module 30, the storage module 31, the timer module 32 and an unillustrated motor are implemented on a printed circuit board PCB and are thus built in a main body MDY of the network connection guiding device 3. Note that the microphone 35 functions as a sound switch turning ON upon sensing a sound equal to or louder than a predetermined level but does not operate peculiarly in the present invention.

[Operations in First Embodiment]

(First Operation)

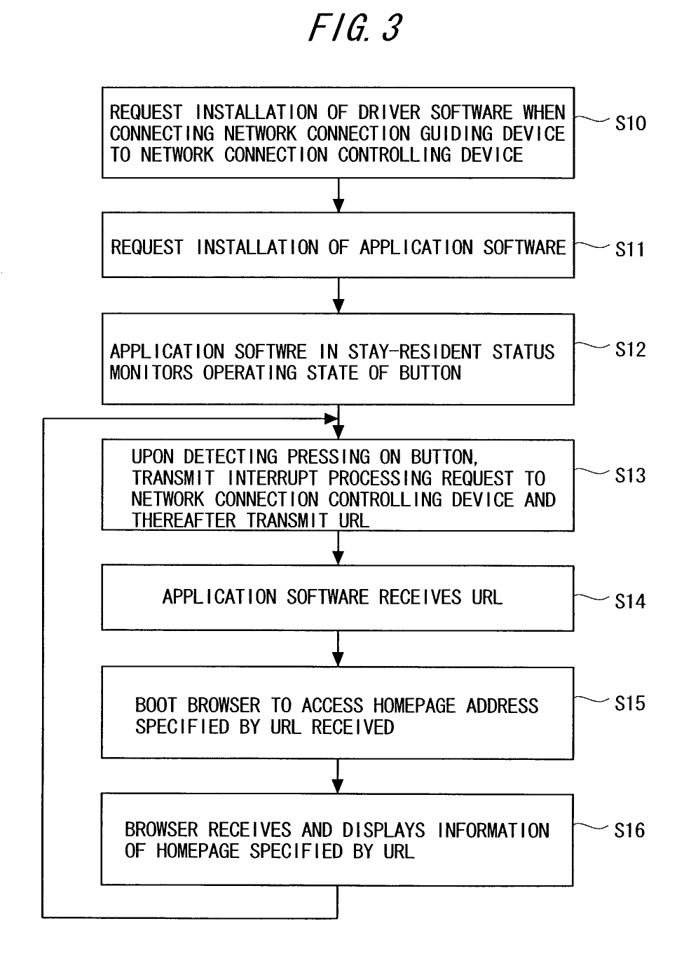

Next, a first operation of the system 1 taking the architecture described above will be explained FIGS. 1 through 3 in combination.

When the user connects the network connection guiding device 3 distributed and received as the mascot robot to the network connection controlling device 2, an operation system (OS: not shown) prompts the user to install the driver software 23 of the connection guide device 3 (processing step S10).

When the driver software 23 is installed, the OS of the connection control device 2 prompts the user to install the application software 21 of the connection guide device 3 (S11). These pieces of software 21, 23, which have been once installed, terminate and stay resident (which will hereinafter simply termed “stay resident”) in the connection control device 2. In a stay-resident status of the application software 21, for instance, an icon corresponding to this status is displayed on the display unit 24.

The installed application software 21 monitors an operation state of the button 33 of the connection guide device 3 with the aid of the driver software 23 via the application program interface (API)(S12).

When the user presses the button 33 of the connection guide device 3 in order to browse a homepage of a provider of the mascot robot, the processing module 30, after detecting this button-pressed state and sending an interrupt process request to the connection control device 2, reads URL, e.g., [www.fj.co.jp/pcsale] pre-stored as a homepage address (network address) in the storage module 31, and transmits URL to the connection control device 2 (S13) The application software 21 of the connection control device 2, which monitors the operation state of the button 33, detects an occurrence of the interrupt process request and receives URL transmitted (S14).

The application software 21 boots the browser 20 to have an access to the homepage address specified by URL received (S15). The browser 20 receives information (content) of the homepage specified by URL from a server 4 accommodated in the Internet 5, and visibly displays the same information on the display unit 24 (S16).

Note that the storage module 31, if still having a space in its memory capacity, may be made to further retain a scrip for surrogating procedures for the homepage, and the script may be read together with URL and then executed. The procedures surrogated herein are procedures for inputting user' ID and password, and authenticating the individual (which is known as an electronic certification). A selection of whether this process is executable or not can be made in the same way with other embodiments that will hereinafter be discussed.

This scheme enables the user to easily access a homepage titled, e.g., [PC sales page] provided by the mascot robot provider, which shows contents of sales of PCs, simply by pressing the button 33, and to browse the detailed contents as the user desires.

(Second Operation)

Next, a second operation of the system 1 adopting the architecture described above, will be described referring to FIGS. 1 and 2.

The application software 21 staying resident in the connection control device 2 is capable of setting a time of occurrence of an event with the aid of the driver software 23 via the application program interface 22. For example, if a sponsor is a broadcasting station, the application software 21 extracts a broadcasting date/time of a program related to the mascot robot of the service provider out of the homepages, and indicates the timer module 32 to set setting the broadcasting date/time through processing by the processing module 30 of the connection guide device 3.

The connection guide device 3, even when a power switch of the connection control device 2 is in an OFF-state, guides the user into watching the program just when it is a set time. More specifically, in the connection guide device 3 supplied with the electricity from an unillustrated built-in battery, the timer module 32 executing a time count notifies the processing module 30 that the set time is reached.

With this notification, the processing module 30 reads digital voice data VIC corresponding to an utterance of voice and an emission of sound effect stored beforehand in the storage module 31, and audibly outputs a time-reached state to the user through the loudspeaker 34. Further, the processing module 30 simultaneously makes luminescent the light emitting display modules 36 disposed in positions corresponding to two eyes of the mascot robot, and operates the robot's arms and head to move, thus visually indicating the time-reached state to the user. Note that these display modes of the time-reached state may be selectively taken.

This scheme enables the user into watching the program provided by the mascot robot provider.

(Third Operation)

Next, a third operation of the system 1 adopting the architecture described above will be explained with reference to FIGS. 1 and 2.

The application software 21 staying resident in the connection control device 2, when the content of the homepage specified by URL stored in the storage module 31 of the connection guide device 3 is updated, guides the user into accessing this homepage with the aid of the driver software 23 via the application program interface 22.

The application software 21 periodically monitors through the browser 20 whether the content of the homepage specified by URL stored in the storage module 31 has been updated. For instance, in a case where the content of the homepage is updated corresponding to selling a new product, the application software 21, when detecting the updating, notifies the processing module 30 of this updating.

The processing module 30, as in the second operational example, operates the loudspeaker 34 and the light emitting display modules 36 and moves the arms and head thereof, thus indicating an occurrence of the updating state to the user. Note that the occurrence of the updating state of the homepage needs indicating in a way distinguishable to the user from displaying the time-reached state.

This scheme enables the user to access the updated homepage provided by the mascot robot provider, simply by pressing the button 33, and to browse the detailed content as the user desires.

[Architecture and Operations in Second Embodiment]

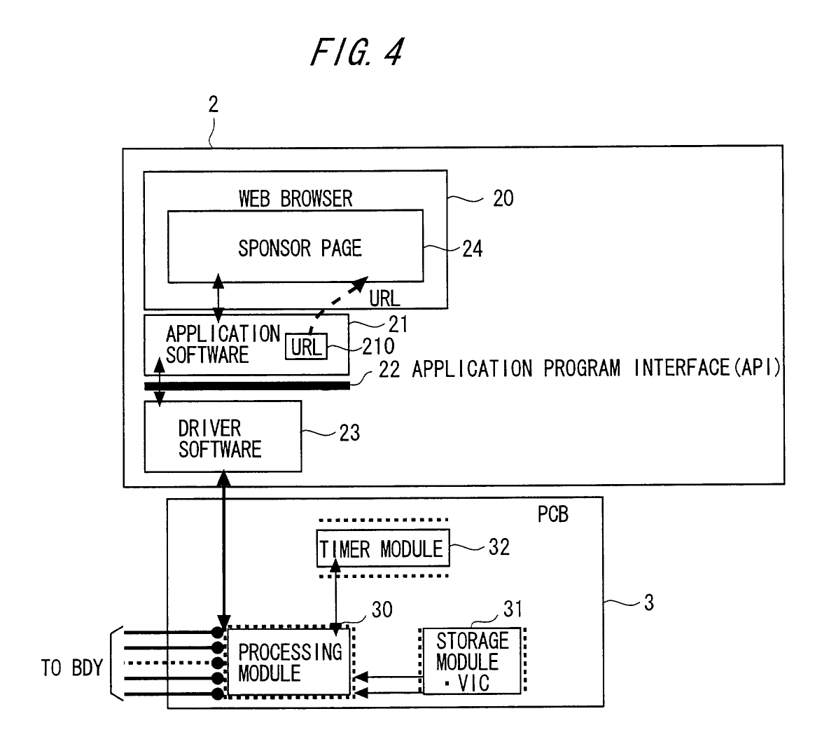

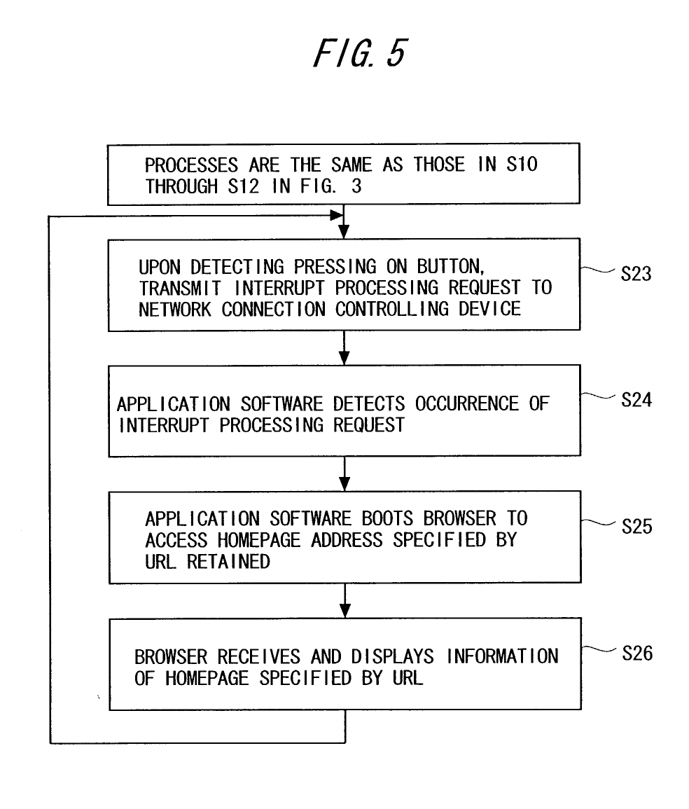

FIG. 4 shows an architecture of a second embodiment of the present invention. FIG. 5 is an explanatory flowchart showing the operations of the same system.

Referring to FIG. 4, the system 1 according to the second embodiment has different points in its architecture from the first embodiment, wherein the application software 21 of the network connection controlling device 2 defined as an information communication terminal device, retains the URL specifying the homepage, and the storage module 31 of the network connection guiding device 3 as a sub I/O device is stored with only the digital voice data VIC.

In the system 1 adopting this architecture, as illustrated in FIG. 5, if the network connection guiding device 3 distributed from the service provider as the mascot robot for the network connection controlling device 2, is connected as an initial connection to the network connection controlling device 2, the same processes as those in processing steps S10 through S12 in the first operational example in the first embodiment, are executed.

When the user presses the button 33 of the connection guide device 3 in order to access the homepage provided by the mascot robot provider, the processing module 30 detects this pressed-state, and transmits an interrupt process request to the connection control device 2 (S23).

The application software 21 of the connection control device 2, which monitors the operation state of the button 33, detects an occurrence of the interrupt process request with the aid of the driver software 23 via the application program interface 22 (S24).

The application software 21 detecting the occurrence of the interrupt process request boots the browser 20 to have an access to the homepage specified by URL retained therein (S25).

The browser 20 receives information (content) of the homepage specified by URL from the server 4 accommodated in the Internet 5, and visibly displays the same information on the display unit 24 (S26).

This scheme enables the user to access the homepage titled, e.g.,[PC sales page] provided by the mascot robot provider, which shows contents of sales of PCs, simply by pressing the button 33, and to browse the detailed contents as the user desires.

Further, in the system 1 according to the second embodiment also, as discussed in the second and third operational examples in the first embodiment, the user can be enticed into watching the program provided by the mascot robot provider, and can be guided into accessing the updated homepage of the mascot robot provider simply by pressing the button 33 and into browsing the detailed content as the user desires.

In the system 1 according to the second embodiment discussed above, the application software 21 retains URL 210 specifying the homepage, and hence there are advantages in which the memory capacity of the storage module 31 of the connection guide device 3 can be reduced to a greater degree, and the above scheme is capable of corresponding more to upgrading of the application software 21 if the homepage address is changed than by the architecture in the first embodiment described above.

[Architecture and Operations in Third Embodiment]

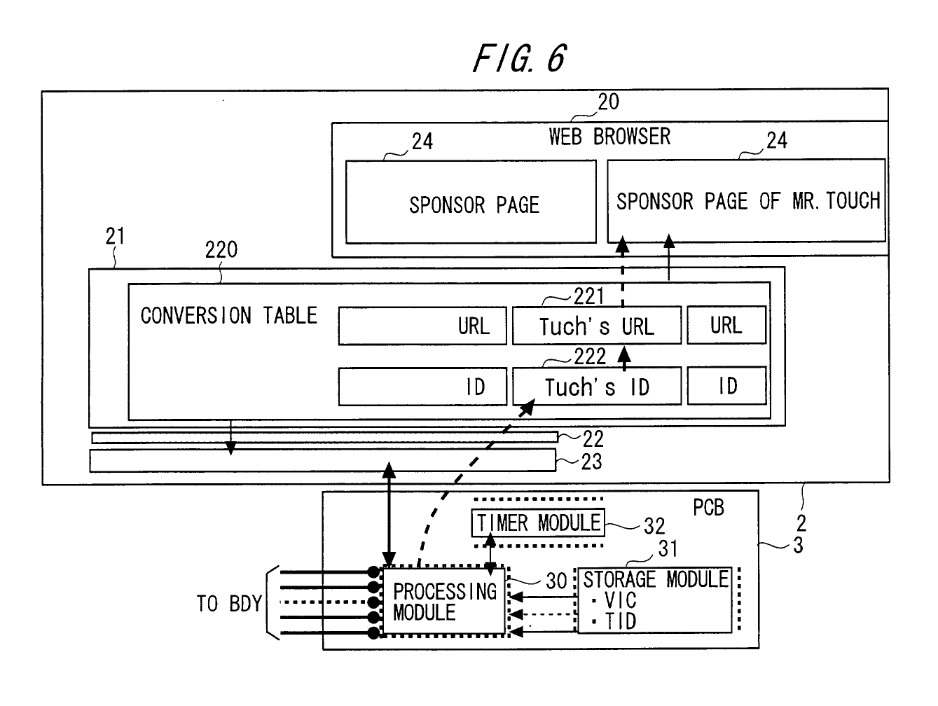

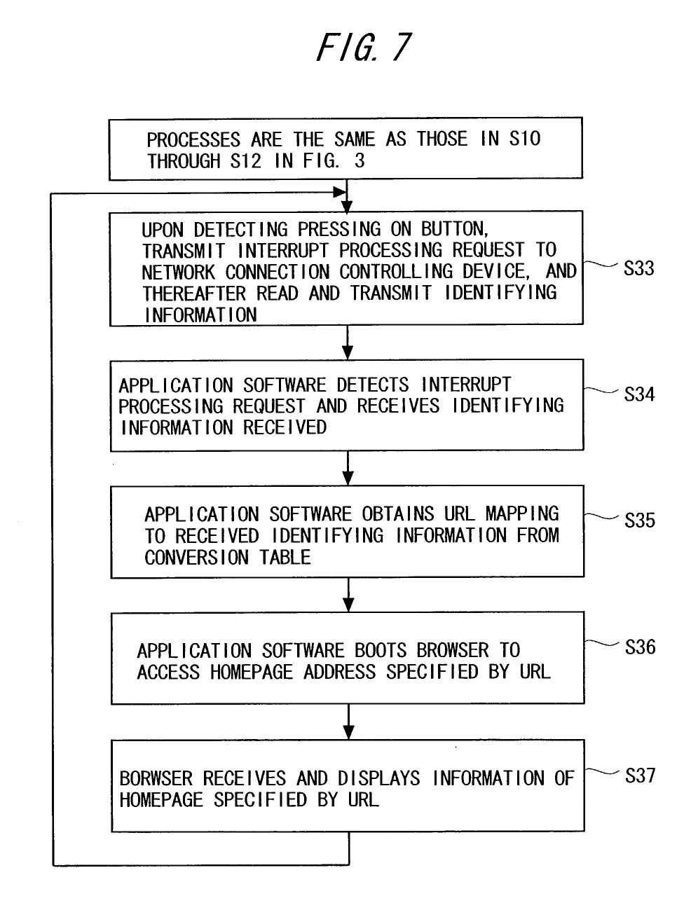

FIG. 6 shows an architecture of the system in a third embodiment of the present invention. FIG. 7 is an explanatory flowchart showing operations of the same system.

Referring to FIG. 6, the system 1 in the third embodiment has differences from the architecture in the first embodiment, wherein the application software 21 of the network connection controlling device 2 serving as the information communication terminal device, retains a conversion table 220 showing a mapping between URL 221 specifying the homepage address and identifying information (ID) 222 for identifying URL 221, and the storage module 31 of the network connection guiding device 3 as the sub I/O device is stored with the digital voice data VIC and identifying information TID corresponding to the identifying information 222.

The system 1 having this architecture, as shown in FIG. 7, when the network connection guiding device 3 receiving the mascot robot distributed from the service provider is connected as an initial connection to the network connection controlling device 2, executes the same processes as those in processing steps S10 through S12 in the first operational example according to the first embodiment.

When the user presses the button 33 of the connection guide device 3 in order to access the homepage provided by the mascot robot provider, the processing module 30, after detecting this pressed-state and transmitting an interrupt process request to the connection control device 2, reads the identifying information TID, previously stored in the storage module 31, for identifying URL specifying the homepage and transmits TID to the connection control device 2 (S33).

The application software 21 of the connection control device 2, which monitors the operation state of the button 33, detects an occurrence of the interrupt process request and receives the identifying information TID transmitted (S34).

The application software 21, when having detected the identifying information 222 corresponding to the received identifying information TID from the conversion table 220, acquires URL 221 mapping to the detected identifying information 222 (S35).

The application software 21 boots the browser 20 to have an access to a homepage specified by URL 221 (S36). The browser 20 receives information (content) of the homepage specified by URL 221 from the server 4 accommodated in the Internet 5, and visibly displays the same information on the display unit 24 (S37).

This scheme enables the user to access the homepage titled, e.g.,[PC sales page] provided by the mascot robot provider, which shows contents of sales of PCs, simply by pressing the button 33, and to browse the detailed contents as the user desires.

Further, in the system 1 according to the third embodiment also, as discussed in the second and third operational examples in the first embodiment, the user can be enticed into watching the program provided by the mascot robot provider, and can be guided into accessing the updated homepage of the mascot robot provider simply by pressing the button 33 and into browsing the detailed content as the user desires.

The system 1 according to the third embodiment discussed above, since the application software 21 retains URL 221 specifying the homepage address, has the advantage of being capable of corresponding more to the upgrading of the application software 21 when the homepage address is changed than by the architecture in the first embodiment.

Further, the conversion table 220 that retains the mapping between the identifying information (ID) and URL, may be automatically or manually updated when a new product appears.

[Architecture and Operations in Fourth Embodiment]

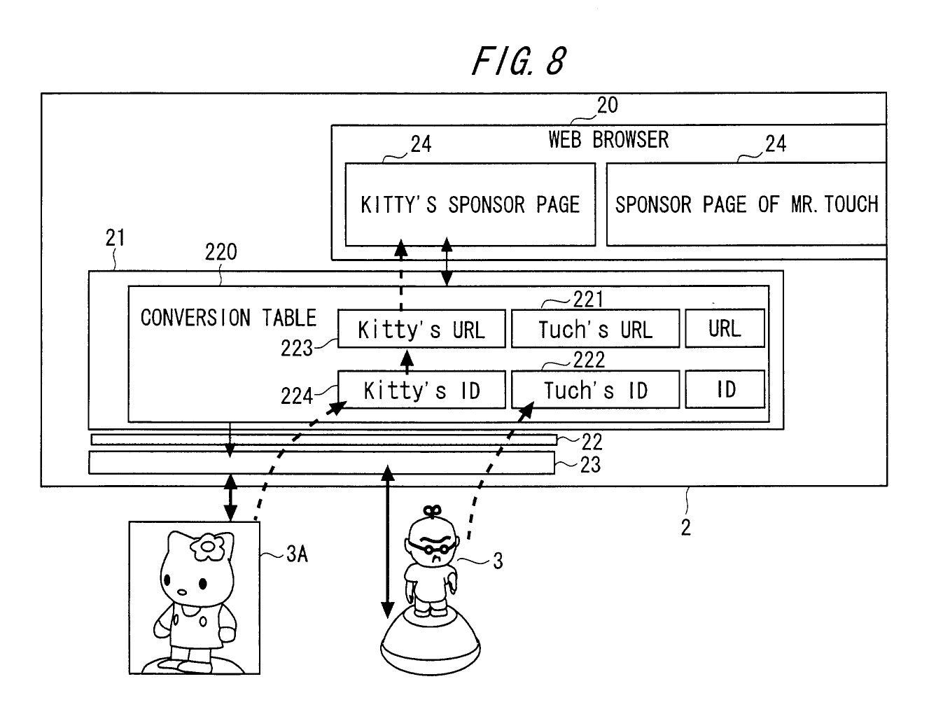

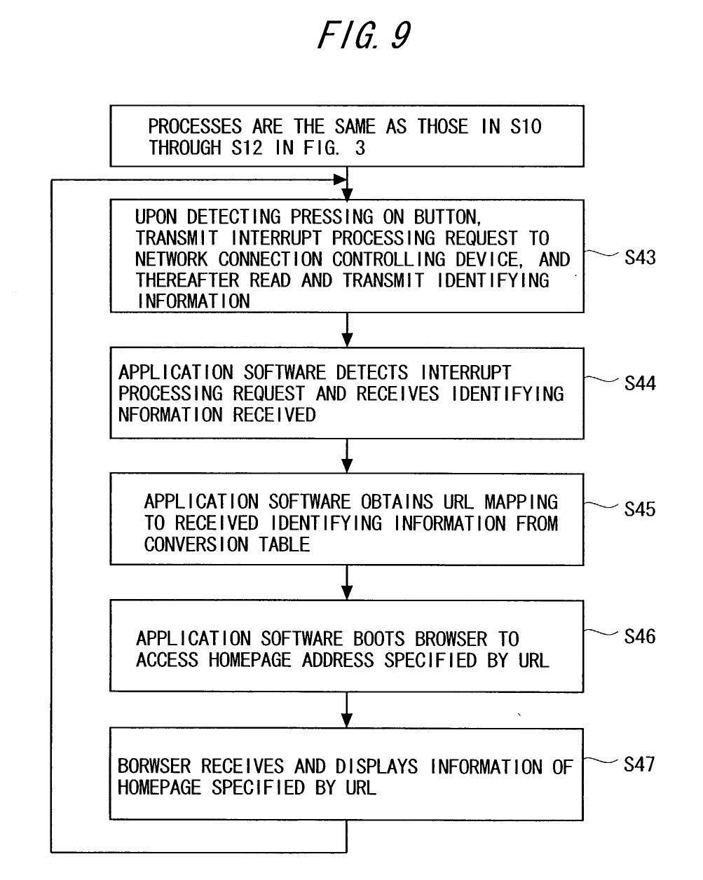

FIG. 8 shows an architecture of the system in a fourth embodiment of the present invention. FIG. 9 is an explanatory flowchart showing operations of the same system.

Referring to FIG. 8, the system 1 in the fourth embodiment has differences from the architecture in the third embodiment, wherein the application software 21 of the network connection controlling device 2 as the information communication terminal device, retains a conversion table 220 showing mappings between two pieces of URLs 221, 223 specifying two pieces of homepage addresses and two pieces of identifying information (ID) 222, 224 for identifying these URLs 221, 223, and the storage units 31 of two types of network connection guiding devices 3, 3A as sub I/O devices are stored with the digital voice data VIC and two pieces of identifying information TID, KID corresponding to the two pieces of identifying information 222, 224.

The system 1 having this architecture, as shown in FIG. 9, when the network connection guiding devices 3, 3A receiving the mascot robots distributed from the service provider are connected as an initial connection to the network connection controlling device 2, executes the same processes as those in processing steps S10 through S12 in the first operational example according to the first embodiment.

When the user presses the button 33 of the connection guide device 3 or 3A in order to access the homepage provided by the mascot robot provider, the processing module 30 corresponding the device 3 or 3A, after detecting this pressed-state and transmitting an interrupt process request to the connection control device 2, reads the identifying information TID or KID, previously stored in the storage module 31, for identifying URL 221 or 223 specifying the homepage, and transmits TID or KID to the connection control device 2 (S43).

The application software 21 of the connection control device 2, which monitors the operation state of the button 33, detects an occurrence of the interrupt process request and receives the identifying information TID or KID transmitted (S44).

The application software 21, when having detected the identifying information 222 or 224 corresponding to the received identifying information TID or KID from the conversion table 220, acquires URL 221 or 223 mapping to the detected identifying information 222 or 224 (S45).

The application software 21 boots the browser 20 to have an access to a homepage specified by URL 221 or 223 (S46). The browser 20 receives information (content) of the homepage specified by URL from the server 4 accommodated in the Internet 5, and visibly displays the same information on the display unit 24 (S47).

This scheme enables the user to selectively access the homepage provided by the plural mascot robot provider simply by pressing the button 33, and to browse the detailed contents as the user desires.

Further, in the system 1 according to the fourth embodiment also, as explained in the second and third operational examples in the first embodiment, the user can be enticed into watching the program provided by the mascot robot provider, and can be guided into accessing the updated homepage of the mascot robot provider simply by pressing the button 33 and into browsing the detailed content as the user desires.

The system 1 according to the fourth embodiment discussed above, since the application software 21 retains URLs 221 and 223 specifying the homepage addresses, has the advantage of being capable of corresponding more to the upgrading of the application software 21 when the homepage address is changed than by the architecture in the first embodiment.

### MODIFIED EXAMPLES

In each of the embodiments discussed above, in response to pressing the button 33, the network connection guiding device 3 notifies the network connection controlling device 2 of URL and ID, however, thee can be adopted such a scheme that the application software 21 of the connection control device 2 detects the pressed-state of the button 33 and requests the connection guide device 3 for URL and ID. Moreover, not the application software 21 but the driver software 23 may retain the conversion table 220.

According to the present invention, an IP address may substitute, as a piece of connecting destination specifying information, for URL specifying the network address from which the network service is provided.

One network connection guiding device according to the present invention takes an external configuration into which an animal, a human being, a robot or an imaginary creature is characterized. Then, the network connection controlling device notifies a connecting destination of the network of a user's action upon this character as input information, and the character is set in motion based on output information obtained from the connecting destination, however, the network connection guiding device may be provided with a function of linking to the homepage in connection. Namely, a display of a Web page is changed by an automatic execution of inputting ID and the password and inputting Yes/No through other button actions.

### First Applied Example

An assumption is that a D-bank using “Kitty” (a registered trademark of Sanrio Corp.) as a mascot on a TV advertisement of the D-Bank itself launches into home banking. The trouble is that customers do not come at all because of URL being hard to memorize, the customer who visited once the D-Bank (on the network) does not come frequently, and soon. On the other hand, the users tend to feel formal the homepage of the Bank and give a wide berth to it.

Such being the case, the D-Bank decided to distribute the mascot robot named “Kitty” as a novelty goods that adopts the system of the present invention described above and is designed to entice the prospective customers into the Bank's own homepage.

The customer is given the mascot robot free of charge and utilizes it as an accessory to the PC. The use of this mascot robot provides a function of jumping to the home banking page of the D-Bank as a sponsor.

The customer, upon pressing the button, entered the home banking page of the D-Bank and found this homepage more friendly than expected, with the result that the customer became a regular customer pressing the button frequently.

### Second Applied Example

A T-Company, an automobile dealer expanding their customers by direct mails felt that the direct mails did not show an effect sufficient for the cost for the direct mails. Such being the case, the T-Company decided to distribute, to their prospective customers, mascot robots of a sports car sold by the T-Company itself as novelty goods.

The customer is given the mascot robot free of charge and utilizes it as an accessory to the PC. The use of this mascot robot provides a function of jumping to a new car sales homepage of the T-Company as a sponsor.

The customer pressed a button of a horn of the mascot robot and browsed frequently the new car sales page of the T-Company. Few of the mascot robots are discarded, and one household requires many, whereby the T-Company could reduce the cost for the DMs to a great degree.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. A network-connection guiding device comprising:
a connection module connecting said network-connection guiding device as an auxiliary input device to a network-connection controlling device controlling a connection to a network; and
a request module making a processing request for making said network-connection controlling device control the connection to the network on the basis of a piece of connecting destination specifying information retained by said network-connection controlling device.

2. A network-connection guiding device comprising:
a connection module connecting said network-connection guiding device as an auxiliary input device to a network-connection controlling device controlling a connection to a network;
a storage module stored with the connecting destination specifying information of which said network-connection controlling device is notified; and
a request module making a processing request for making said network-connection controlling device control the connection to the network on the basis of the connecting destination specifying information.

3. A network-connection guiding device comprising:
a connection module connecting said network-connection guiding device as an auxiliary input device to a network-connection controlling device controlling a connection to a network;
a request module making a processing request for making said network-connection controlling device control the connection to the network on the basis of a piece of connecting destination specifying information retained by said network-connection controlling device; and
a storage module stored with identifying information for identifying the connecting destination specifying information.

4. A network-connection guiding device according to claim 1, wherein the connecting destination specifying information is URL or an IP address mapping to a network address from which a network service is provided.

5. A network-connection guiding device according to claim 1, further comprising:
a detection module detecting an even occurrence time on the basis of time information acquired from the network connecting destination specified by the connecting destination specifying information; and
a display unit displaying an arrival of the event occurrence time leastwise visibly or audibly.

6. A network-connection guiding device according to claim 1, further comprising a display unit displaying an occurrence of an updating state leastwise visibly or audibly on the basis of update information acquired from the network connecting destination specified by the connecting destination specifying information.

7. A network-connection guiding device according to claim 1, wherein said network-connection guiding device has an external configuration associated with a network service specified by the connecting destination specifying information.

8. A network-connection guiding device according to claim 1, wherein said network-connection guiding device has an external configuration into which an animal, a human being, a robot or an imaginary creature is characterized,
the network connection destination is notified of input information as auser's action on said character via said network-connection controlling device, and
said character is set in motion based on output information obtained from this connecting destination.

9. A network-connection guiding method comprising:
detecting a processing request from a network-connection guiding device as an auxiliary input device; and
controlling a connection to a network on the basis of a piece of connecting destination specifying information retained therein when detecting the processing request.

10. A network-connection guiding method comprising:
detecting a processing request from a network-connection guiding device as an auxiliary input device; and
controlling a connection to a network on the basis of a piece of notified connecting destination specifying information when detecting the processing request.

11. A network-connection guiding method comprising:
detecting a processing request from a network-connection guiding device as an auxiliary input device; and
controlling a connection to a network on the basis of a piece of retained connecting destination specifying information corresponding to the notified identifying information when detecting the processing request.

12. A storage medium stored with a program executed by a computer, said program comprising:
detecting a processing request from a network-connection guiding device as an auxiliary input device; and
controlling a connection to a network on the basis of a piece of connecting destination specifying information retained therein when detecting the processing request.

13. A storage medium stored with a program executed by a computer, said program comprising:
detecting a processing request from a network-connection guiding device as an auxiliary input device; and
controlling a connection to a network on the basis of a piece of notified connecting destination specifying information when detecting the processing request.

14. A storage medium stored with a program executed by a computer, said program comprising:
detecting a processing request from a network-connection guiding device as an auxiliary input device; and
controlling a connection to a network on the basis of a piece of retained connecting destination specifying information corresponding to the notified identifying information when detecting the processing request.

15. A network-connection guiding method comprising:
connecting a network-connection guiding device to a network-connection controlling device wherein said network-connection guiding device is distributed as a novelty goods, is connectable to said network-connection controlling device, and includes an operation mechanism; and
setting said network-connection guiding device in motion by receiving pre-stored motion information from a network connecting destination on the basis of connecting destination specifying information retained by said network-connection controlling device.

16. A network-connection guiding method comprising:
connecting a network-connection guiding device to a network-connection controlling device wherein said network-connection guiding device is distributed as a novelty goods, is connectable to said network-connection controlling device, stored with connecting destination specifying information, and includes an operation mechanism;
notifying said network-connection controlling device of the connecting destination specifying information from said network-connection guiding device; and
setting said network-connection guiding device in motion by receiving pre-stored motion information from a network connecting destination on the basis of connecting destination specifying information.

17. A network-connection guiding method comprising:
connecting a network-connection guiding device to a network-connection controlling device wherein said network-connection guiding device is distributed as a novelty goods, is connectable to said network-connection controlling device, stored with identifying information for identifying connecting destination specifying information, and includes an operation mechanism;
notifying said network-connection controlling device of the identifying information for identifying the connecting destination specifying information retained by said network-connection controlling device from said network-connection guiding device; and
setting said network-connection guiding device in motion by receiving pre-stored motion information from a network connecting destination on the basis of connecting destination specifying information.
